(19) United States
(12) Patent Application Publication
(10) Pub. No.: US 2015/0217630 A1
(43) Pub. Date: Aug. 6, 2015

(54) Hardware-free, non-marking shade assembly, kit and method of installation and use, for square or horizontally-elongated portholes with top-hinged covers

(71) Applicant: Valerie Kay Spitler, New York, NY (US)

(72) Inventor: Valerie Kay Spitler, New York, NY (US)

(21) Appl. No.: 13/999,267

(22) Filed: Feb. 5, 2014

(51) Int. Cl. B60J 3/00; B23P 19/04

(52) U.S. Cl. CPC B60J 3/002; B23P 19/04

(57) ABSTRACT

In accordance with the invention, the device is provided for constructing a hardware-free, non-marking shade for square or horizontally-elongated, top-hinged boat portholes, comprising a panel of lightweight, yet durable material that is capable of filtering or blocking light and views, that can be rolled onto itself, and that has horizontal spaces across the top end of said panel, and; short and long ties, made of material that holds a knot, and where the short ties are used to secure the panel to the hinges of the porthole cover and the long ties are used to adjust the panel to either an opened or closed position over the porthole cover, and said ties can either be sewn directly to the panel or can be inserted through spaces at the top of the panel. Method steps related to installation, use and removal are also recited.

### CROSS-REFERENCE TO RELATED APPLICATIONS

None.

### BACKGROUND OF THE INVENTION

This invention pertains to the pleasure boating field. Most pleasure boats, both sail and power, are equipped with portholes that allow light into the living quarters of the vessel, and allow the vessel's occupants to see outside. Many of these portholes have a cover that is hinged on top of the porthole, and that opens and closes from inside the boat (see for example, U.S. Pat. No. 4,095,640 by Frank S. Berkey, Jr., dated Jun. 20, 1978 and U.S. Pat. No. 2,466,549 by Peter N. Landine, dated Jan. 25, 1945). When in the open position, the porthole cover allows ventilation into the living quarters, in addition to the light. Typically, the covers are closed and tightly latched when the vessel is underway to prevent water from entering the living quarters to maintain the beauty of the living quarters, and to prevent the boat from filling with water and sinking. At port or at anchor, the occupants typically open the porthole covers, partially or fully, to provide ventilation to the living quarters.

To provide shade and privacy for occupants, some vessels are equipped with blinds, shades or curtains over the portholes in one of two ways. Either the blinds or shades are mounted directly over the glass, fixed to the rim of the porthole cover via a gasket, in a semi-permanent fashion (see U.S. Pat. No. 5,608,990 by James H. Kyle, dated Mar. 11, 1997), or they are mounted to the interior of the boat above the porthole.

In the first manner cited above, the blind or shade must be custom fitted over the glass, increasing the cost of the product. Further, to have a clear view out of the porthole window, the blind or shade must either be removed, or the porthole cover must be opened.

In the second method, the blind, shade or curtain hangs from hardware that is installed directly to the boat's interior with snaps, screws, glue or other method. These products derive from window treatments in the home and are not particularly adapted to a boating environment. Within the seconds method are retractable blinds with a locking mechanism, fixed above the porthole, rolled down for shade and privacy and up to see outside; horizontally pleated blinds, affixed above the porthole, unsnapped to be in the shade/privacy position and folded up and snapped to be in the open view position; and vertically pleated blinds or curtains that hang from hardware affixed above the porthole.

While these products allow the occupants to see outside when they are in the opened position, they require permanently installed hardware, that not only mars the interior of the boat, but is also subject to corrosion and must be maintained. These products require less customization than those mounted directly over the glass, but they are also relatively expensive, they add weight to the vessel, and they are not particularly attractive. The roller blinds and the horizontally pleated blinds, if not well rolled or secured, are subject to tearing in rough seas, as the vessel rolls and pitches.

What is needed is a blind or shade that, when installed in the “open” position over a closed porthole, allows a clear view to outside; that for installation and use requires no hardware; and that fits a variety of porthole covers therefore avoiding the high cost of customization. Further, it should be lightweight, yet durable. Finally, the device needs to be easy to install and use and should be attractive for the pleasure-boating community.

### BRIEF SUMMARY OF THE INVENTION

My invention is a simple-to-install, simple-to-use, inexpensive, sea-worthy, hardware-free, non-marking shade assembly for square or horizontally-elongated portholes with top-hinged covers on boats. The devices of the invention include a rectangular light-limiting panel that can be rolled, bunched or folded onto itself, ties that are mildew resistant, that can withstand chafing and that can hold a knot, and the method and kit for assembling, installing and using (including removing) the invention.

### BRIEF DESCRIPTION OF THE SEVERAL VIEWS OF THE DRAWING

FIG. 1 shows a perspective view with the panel and ties of the invention installed over the porthole cover in the interior of the vessel in the “closed” position for shade and privacy.

FIG. 2 shows a perspective view with the panel and ties of the invention installed over the porthole cover in the interior of the vessel in the “open” position for maximum views and light.

FIG. 3 shows a plan view of the panel and ties, unassembled and uninstalled.

FIG. 3A shows a detail view of the top of a panel made of bamboo sticks stitched together, with spaces between sticks for insertion of short ties.

FIG. 4 shows a partial detail view, with the porthole cover fully opened, of the intermediate installed position of the short tie around the hinge, between the porthole frame and the porthole cover.

FIG. 5 shows a plan view of the parts of a kit: a plurality of panels, a plurality of short ties, a plurality of long ties, and an instruction sheet.

### DETAILED DESCRIPTION OF THE INVENTION

### Preferred Embodiment

This hardware-free, non-marking shade assembly for controlling privacy and light in a vessel with top-hinged, square or horizontally-elongated portholes, in accordance with a preferred embodiment of the invention, includes a panel 13, a long tie 14, and short ties 15.

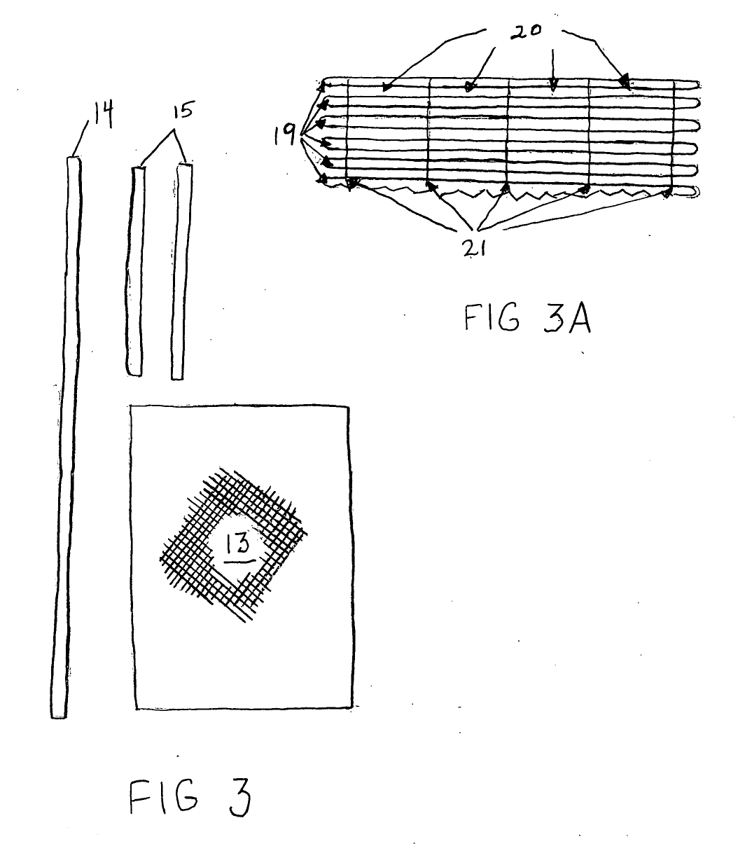

The panel 13, 13a, 13b covers the porthole cover frame 16 and glass 17 in the interior of the vessel, and is anticipated to be made of any lightweight, opaque, or partly opaque material that is flexible enough to be rolled onto itself. In the preferred embodiment, the panel 13, 13a, 13b is made from a plurality of bamboo sticks 19, held together with stitching 2 to form a flat panel. The width of the panel 13, 13a, 13b is anticipated to coincide with the width of the porthole 10 for which it is intended, where the tolerance for fit is one to two inches, or more. It is anticipated that a panel 13, 13a, 13b twelve inches wide will fit many standard small porthole covers, and a panel eighteen to twenty inches wide will fit many standard larger porthole covers. The length of the panel is anticipated to be approximately fifteen to twenty inches, for a porthole cover measuring five to seven inches from top to bottom. The extra length gives weight to the shade so that it does not fly about when in the “closed” position (FIG. 1). The material and the dimensions of the panel may vary, as those skilled in the art will envision. At the top of the panel are holes where the ties will be inserted. In the preferred embodiment the spaces 20 between the bamboo sticks 19 provide the holes 21 (FIG. 3A). In another embodiment, the holes are cut into the panel, at regular intervals to accommodate varying sizes of porthole covers, that is, the installer chooses which holes to use in each installation.

The short ties 15, 15a, 15b are used to attach the panel 13, 13a, 13b to the hinges 11 of the porthole 10. In the preferred embodiment, the short ties 15, 15a, 15b are loose, and must be inserted through holes at the top of the panel before the panel 13, 13a, 13b is tied to the hinges 11. In another embodiment, the ties are sewn to the panel 13, 13a, 13b. In the preferred embodiment, the exact positions of the hinges 11 does not need to be known, whereas in the latter embodiment, knowing the positions of the hinges 11 is necessary prior to manufacture.

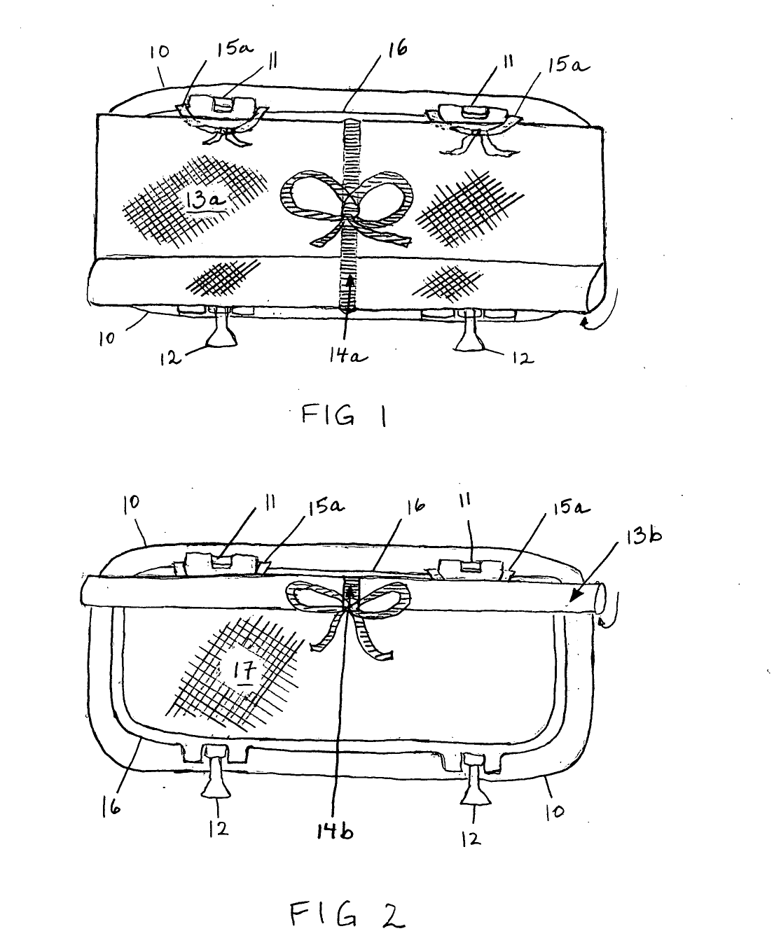

The long tie 14, 14a, 14b is used to adjust the position of the panel 13, 13a, 13b. FIG. 1 shows the panel 13a in the closed position, where the panel 13a is rolled up from its bottom to coincide with the bottom of the porthole 10, just above the dogs 12. FIG. 2 shows the panel 13b in the open position, where the panel 13b is rolled up from its bottom as far as possible to reveal the porthole cover 16 and 17 and thereby allowing the maximum light and view into the vessel. The long tie 14, 14a, 14b, which passes between the porthole cover glass 17 and the panel 13, 13a, 13b, is used to tie the panel 13, 13a, 13b in its rolled positions. In the preferred embodiment the long tie is loose, but in another embodiment the long tie can be sewn to the panel.

The ties 14, 14a, 14b, 15, 15a, 15b are anticipated to be ribbons approximately ⅝″ wide, made of satin. The short ties 15, 15a, 15b are anticipated to be twelve inches long, and the long tie is anticipated to be thirty-six inches long.

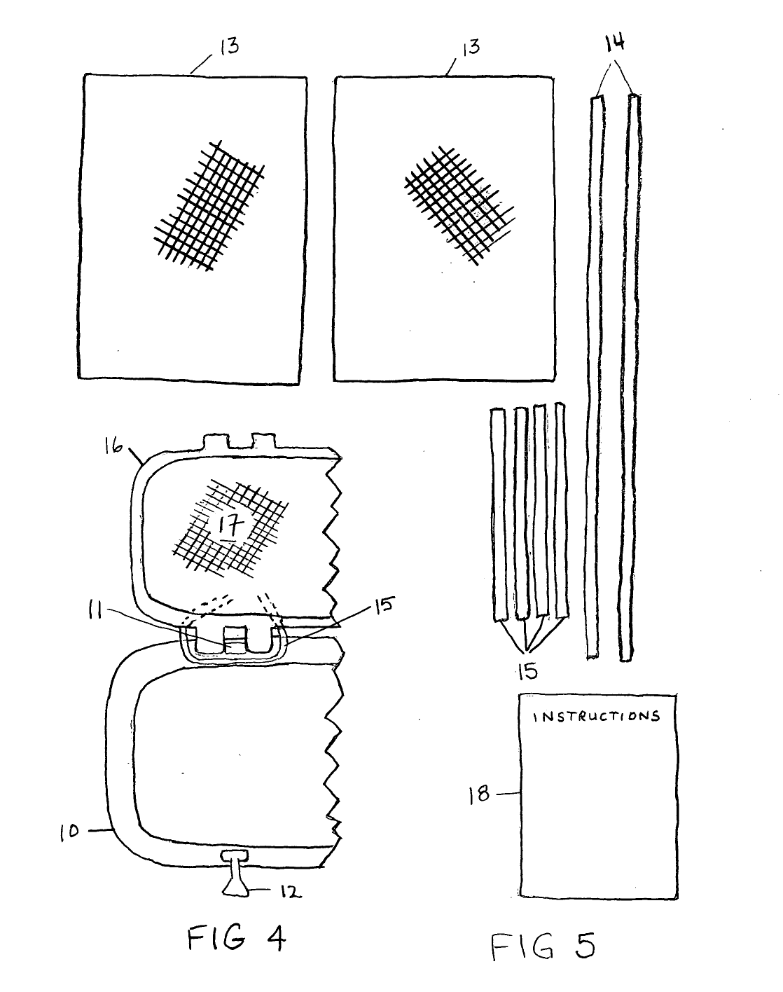

FIG. 4 shows a kit comprising a plurality of panels 13, a plurality of long ties 14, a plurality of short ties 15 and an instruction sheet 18 for the assemblage, installation and use of one or more shades.

The method for installing and using the preferred embodiment consists of the following steps: holding the panel up to the porthole to estimate the position of the short ties in the panel with respect to the hinges of the port cover; inserting the short ties through the spaces between the top two bamboo sticks in the panel corresponding to the position previously estimated; releasing the dogs (latches) of the porthole cover and opening slightly said cover; with the short ties inserted through the spaces of panel, holding the panel flat against the porthole cover with the short ties positioned against the porthole cover hinges; passing one end of a short tie behind the corresponding hinge (see FIG. 5 for position of short tie behind hinge); grabbing the ends of the short tie in prior step with each hand and pulling tightly so that top of panel is firmly against hinge; then tying a knot in the short tie to secure panel in said position; repeating prior steps for each hinge of said porthole cover; closing porthole cover; manually adjusting said panel to hang laterally-centered over porthole cover; passing long tie between port cover and attached panel, and tying a half knot in said long tie; rolling bottom of said panel to coincide with bottom of porthole opening; tying the long tie in knot or bow, to secure bottom of panel in rolled“down” position (FIG. 1); tightening the dogs (latches) of the porthole cover; releasing knot or bow of the long tie; rolling bottom of said panel to coincide with top of port opening; tying the long tie in a knot or bow, to secure bottom of panel in rolled, “up” position (FIG. 2). To remove the preferred embodiment, untie or cut the short ties.

While the embodiments herein are at present considered to be preferred, it will be understood that numerous variations and modifications may be made therein by those skilled in the art, and it is intended to cover in the appended claims all such variations and modifications as fall within the true spirit and scope of the invention.

What is claimed is:

1. A hardware-free, non-marking shade assembly for controlling the amount of light which passes through an opening in a vessel comprising:
a square or horizontally-elongated port or window in the opening in the vessel and a top-hinged cover with latching dogs of said port or window;
a light-limiting, flexible and lightweight panel that covers the width of the port or window and extends at least to the height of the port or window and rolls, bunches or folds vertically onto itself, and includes a top section that has regularly-spaced openings in it;
hardware-free, non-marking means, including ribbon means, for attaching said panel, through said openings, to hinges of porthole covers by tying or securing said means around said hinges;
and hardware-free means, including ribbon means, for adjusting length of said panel over porthole cover by passing said means between said porthole cover and said panel, and tying in a bow or knot or securing said means to secure panel in temporary, desired position.

2. A hardware-free, non-marking shade assembly for controlling the amount of light which passes through an opening in a vessel comprising:
a square or horizontally-elongated port or window in the opening in the vessel and a top-hinged cover with latching dogs of said port or window;
a light-limiting, flexible and lightweight panel that covers the width of the port or window and extends at least to the height of the port or window and rolls, bunches or folds vertically onto itself, and includes a top section that has ribbons or other means attached to it, said means to be tied or secured around the hinges of porthole cover;
and hardware-free means, including ribbon means, for adjusting length of said panel over porthole cover by passing said means between said porthole cover and said rolled panel, and tying in a bow or knot or securing said means to secure rolled panel in temporary, desired position.

3. A hardware-free, non-marking shade assembly for controlling the amount of light which passes through an opening in a vessel comprising:
a square or horizontally-elongated port or window in the opening in the vessel and a top-hinged cover with latching dogs of said port or window;
a light-limiting, flexible and lightweight panel that covers the width of the port or window and extends at least to the height of the port or window and rolls, bunches or folds vertically onto itself, and includes a top section that has regularly-spaced openings in it and has a ribbon or other means attached to it at the mid-length of said means, said means centered laterally on top section and said means used for adjusting length of said panel over porthole cover by passing said means between said porthole cover and said rolled panel, and tying in a bow or knot or securing said means to secure rolled panel in temporary, desired position;
hardware-free, non-marking means, including ribbon means, for attaching said panel, through said openings, to hinges of porthole covers by tying or securing said means around the said hinges.

4. A hardware-free, non-marking shade assembly for controlling the amount of light which passes through an opening in a vessel comprising:
a square or horizontally-elongated port or window in the opening in the vessel and a top-hinged cover with latching dogs of said port or window;
a light-limiting, flexible and lightweight panel that covers the width of the port or window and extends at least to the height of the port or window and rolls, bunches or folds vertically onto itself, and includes a top section that has ribbons or other means attached to it,
one of said means attached at the mid-length of said means, and said means centered laterally on top section and said means used for adjusting length of said panel over porthole cover by passing said means between said porthole cover and said rolled panel, and tying in a bow or knot or securing said means to secure rolled panel in temporary, desired position; and
remainder of said means, attached at mid-length of said means, and attached to top of panel at intervals coinciding with hinges on porthole covers, and to be tied or secured around the hinges of said porthole cover.

5. The method of installation and use of the assembly of claim 1, comprising the steps of:
(a) holding the panel up to the port or window to estimate the position of the means in the panel with respect to the hinges of the port cover
(b) inserting the means through the holes in the panel corresponding to the position estimated in step (a)
(c) releasing the dogs (latches) of the port cover and opening slightly said cover
(d) with attaching means inserted through holes of panel, holding the panel flat against the port cover with attaching means corresponding to port cover hinges
(e) passing one attaching means behind corresponding hinge
(f) grabbing the ends of said attaching means in prior step with each hand and pulling tightly so that top of panel is firmly against hinge, then tying a knot to secure panel in said position
(g) repeating steps (e) and (f) for each hinge of said port cover
(h) closing port cover
(i) manually adjusting said panel to hang laterally-centered over port cover
(j) passing said adjusting means between port cover and attached panel, and tying a half knot in said adjusting means, or securing otherwise
(k) rolling, bunching or folding bottom of said panel to coincide with bottom of port opening
(l) tying adjusting means in knot or bow, or securing otherwise, to secure bottom of panel in rolled, bunched or folded “down” position
(m) tightening the dogs (latches) of the port cover
(n) releasing knot or bow of adjusting means
(o) rolling, bunching or folding bottom of said panel to coincide with top of port opening, and
(p) tying adjusting means in knot or bow, or securing otherwise, to secure bottom of panel in rolled, bunched or folded “up” position.
(q) To remove panel, untie or cut the attaching means of steps (a) through (g).

6. The method of installation and use of the assembly of claim 2:
(a) releasing the dogs (latches) of the port cover and opening slightly said cover
(b) with means attached to panel, holding the panel flat against the port cover with means corresponding to port cover hinges
(c) passing one attached means behind corresponding hinge
(d) grabbing the ends of the attached means in prior step with each hand and pulling tightly so that top of panel is firmly against hinge, then tying a knot to secure panel in said position
(e) repeating steps (c) and (d) for each hinge of said port cover
(f) closing port cover
(g) manually adjusting said panel to hang laterally-centered over port cover
(h) passing adjusting means between port cover and panel, and tying a half knot in said adjusting means, or securing otherwise
(i) rolling, bunching or folding bottom of said panel to coincide with bottom of port opening
(j) tying adjusting means in secure knot or bow, or securing otherwise, to secure bottom of panel in rolled, bunched or folded “down” position
(k) tightening the dogs (latches) of the port cover
(l) releasing knot or bow of adjusting means
(m) rolling, bunching or folding bottom of said panel to coincide with top of port opening
(n) tying adjusting means in secure knot or bow, or securing otherwise, to secure bottom of panel in rolled, bunched or folded “up” position
(o) tightening the dogs (latches) of the port cover.
(p) To remove panel, untie or cut the attaching means of steps (b) through (e).

7. The method of installation and use of the assembly of claim 3:
(a) holding the panel up to the port or window to estimate the position of the means in the panel with respect to the hinges of the port cover
(b) inserting the means through the holes in the panel corresponding to the position estimated in step (a)
(c) releasing the dogs (latches) of the port cover and opening slightly said cover
(d) with attaching means inserted through holes of panel, holding the panel flat against the port cover with attaching means corresponding to port cover hinges
(e) passing one attaching means behind corresponding hinge
(f) grabbing the ends of said attaching means in prior step with each hand and pulling tightly so that top of panel is firmly against hinge, then tying a knot to secure panel in said position
(g) repeating steps (e) and (f) for each hinge of said port cover
(h) closing port cover
(i) manually adjusting said panel to hang laterally-centered over port cover
(j) allowing one end of adjusting means to pass between port cover and attached panel, with other end passing in front of attached panel, and tying a half knot in said adjusting means, or securing otherwise
(k) rolling, bunching or folding bottom of said panel to coincide with bottom of port opening
(l) tying adjusting means in knot or bow, or securing otherwise, to secure bottom of panel in rolled, bunched or folded “down” position
(m) tightening the dogs (latches) of the port cover
(n) releasing knot or bow of adjusting means
(o) rolling, bunching or folding bottom of said panel to coincide with top of port opening, and
(p) tying adjusting means in knot or bow, or securing otherwise, to secure bottom of panel in rolled, bunched or folded “up” position.
(q) To remove panel, untie or cut the attaching means of steps (a) through (g).

8. The method of installation and use of the assembly of claim 2:
(a) releasing the dogs (latches) of the port cover and opening slightly said cover
(b) with means attached to panel, holding the panel flat against the port cover with means corresponding to port cover hinges
(c) passing one attached means behind corresponding hinge
(d) grabbing the ends of the attached means in prior step with each hand and pulling tightly so that top of panel is firmly against hinge, then tying a knot to secure panel in said position
(e) repeating steps (c) and (d) for each hinge of said port cover
(f) closing port cover
(g) manually adjusting said panel to hang laterally-centered over port cover
(h) allowing one end of adjusting means to pass between port cover and attached panel, with other end passing in front of attached panel, and tying a half knot in said adjusting means, or securing otherwise
(i) rolling, bunching or folding bottom of said panel to coincide with bottom of port opening
(j) tying adjusting means in secure knot or bow, or securing otherwise, to secure bottom of panel in rolled, bunched or folded “down” position
(k) tightening the dogs (latches) of the port cover
(l) releasing knot or bow of adjusting means
(m) rolling, bunching or folding bottom of said panel to coincide with top of port opening
(n) tying adjusting means in secure knot or bow, or securing otherwise, to secure bottom of panel in rolled, bunched or folded “up” position, and
(o) tightening the dogs (latches) of the port cover.
(p) To remove panel, untie or cut the attaching means of steps (b) through (e).

9. A kit comprising panels, means and instructions of claims 1 and 5. In this kit, at manufacture, neither the “attaching” means nor the “adjusting” means are attached to the panels.

10. A kit comprising panels, means and instructions of claims 2 and 6. In this kit, at manufacture, the “attaching” means are attached to the panel, and the “adjusting means” are not attached to the panel.

11. A kit comprising panels, means and instructions of claims 3 and 7. In this kit, at manufacture, the “attaching” means are not attached to the panels, but the “adjusting” means are attached to the panels.

12. A kit comprising panels, means and instructions of claims 4 and 8. In this kit, at manufacture, all means are attached to the panels.

13. The combination of claim 1 or claim 2 or claim 3 or claim 4 whereby said panel is made of a plurality of bamboo sticks or other lightweight material, each stick of similar diameter and length, a length that covers the length of said porthole or window, and said plurality of bamboo sticks are lain one next to the other in a plane, with the tops of said sticks adjacent to one another, and the bottoms of said sticks adjacent to one another and said sticks are stitched together such that the sticks can be rolled and such that there remains a small gap between successive sticks, such gaps representing horizontal slits of claim 1 and claim 3.

14. The combination of claim 1 or claim 2 or claim 3 or claim 4 whereby said panel is made of any lightweight, mildew resistant and flexible material.

15. The combination of claim 1 or claim 2 or claim 3 or claim 4 whereby said means are ribbons or fabric or other material that are mildew resistant, chafe resistant, and capable of holding a knot.

16. The combination of claim 1 or claim 2 or claim 3 or claim 4 whereby said means are ribbon or fabric or other material that are mildew resistant and chafe resistant and said ribbon or fabric or other material includes an attachment, such as Velcro or other attachment that replaces the need for a knot or bow.
